(19) United States
(12) Patent Application Publication
(10) Pub. No.: US 2013/0051961 A1
(43) Pub. Date: Feb. 28, 2013

(54) CONSTRUCTION MACHINE HAVING A HEATABLE MATERIAL TRANSPORT DEVICE

(71) Applicants: Michael Diesner, Wilhelmsfeld (DE); Helmut Kessler, Kaiserslautern (DE); Steffen Fickeisen, Bad Durkheim (DE)

(72) Inventors: Michael Diesner, Wilhelmsfeld (DE); Helmut Kessler, Kaiserslautern (DE); Steffen Fickeisen, Bad Durkheim (DE)

(73) Assignee: JOSEPH VOGELE AG, Ludwigshfen/Rhein (DE)

(21) Appl. No.: 13/640,531

(22) PCT Filed: Mar. 18, 2011
(86) PCT No.: PCT/EP2011/001342

§ 371 Date: Nov. 6, 2012

(30) Foreign Application Priority Data
Apr. 16, 2010 (DE) 20 2010 005 125.8

(51) Int. Cl. B60P 1/36; E01C 19/48

(52) U.S. Cl. 414/507

(57) ABSTRACT

The invention relates to a construction machine having a drive, which can be operated by means of a fuel, a material transport device, and a heating device for heating the material transport device and/or the material transported on the material transport device. The heating device is a radiant heater, which can be operated with the same fuel as the drive of the construction machine.

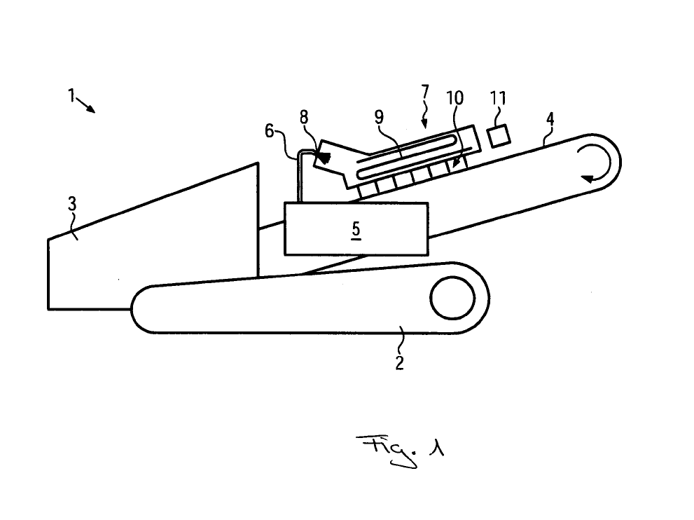

### CROSS REFERENCE TO PRIOR APPLICATIONS

This is a U.S. National Phase application under 35 U.S.C. §371 of International Patent Application No. PCT/EP2011/001342, filed Mar. 18, 2011, and claims the priority of German Patent Application No. 202010005125.8, filed Apr. 16, 2010 both of which are incorporated by reference herein in their entirety. The International Application published in German on Oct. 20, 2011 as WO 2011/128019 under PCT Article 21(2).

### FIELD OF THE INVENTION

The present invention relates to a construction machine having a device for heating material to be transported.

### BACKGROUND OF THE INVENTION

Examples of the construction machines of the present invention are road pavers and feeders for supplying such road pavers with paving mixture. The construction machine can be self-propelled by means of a drive. A heating device prevents the transported material (e.g. bituminous paving mixture) from cooling off too soon and too quickly due to the contact with the material transport device or during the transport on the material transport device. By keeping the material at a higher temperature, the time available for processing the transported material (for example, bituminous paving mixture) is extended.

The use of a gas heater or electric heating elements as a heating device for heating a material transport device is already known. Both variants have disadvantages, however. A gas heater is disadvantageous because the gas must be stockpiled, for example in bottles on the construction machine. There is a risk that these bottles become empty during the operation of the construction machine without this fact being noticed in a timely fashion. The gas bottles furthermore take up space on the construction machine. Electric heating elements, on the other hand, are disadvantageous because their operation requires that combustion energy be converted into electrical energy. The degree of efficiency of electrical heating elements is therefore very low.

The object of the present invention is to improve a construction machine with the simplest possible design, to the effect that more efficient heating of the material transport device is made possible.

### SUMMARY OF THE INVENTION

This object is solved by the construction machine of the present invention 1

In the construction machine according to the invention, the heating device is or comprises a radiant heater that can be operated using the same fuel as the drive of the construction machine. In this way, the necessity of having to keep a supply of a first fuel for the drive and a second fuel or another operating resource for the heating device is eliminated. The drive of the construction machine can be, for example, a diesel combustion engine. The heating device can then also be a radiant heater with a diesel burner. Diesel is thereby used as the fuel for both the drive motor and the heating device.

It is particularly advantageous if the fuel is stockpiled in a common tank both for the drive motor and for the burner of the heating device. This ensures that there is sufficient fuel for operating the heating device throughout the entire operating time of the construction machine. In one embodiment a tank display is provided on such a tank, whereby the operator of the construction machine is informed of the filling level of the tank by means of this tank display.

The operation of the construction machine is particularly convenient if the heating device can be operated from a control stand of the construction machine. In one embodiment the heating unit is switched on and off and its heating output changed with controls that are on the control stand. Unlike in the case of conventional gas heaters for conveyor belts, the present invention eliminates the need to have direct access to the combustion points of the gas heater in order to preheat the glow plugs before operation, to light the burner and to have the burning process controlled by the operator.

A unit for switching off the heating device in the event the material transport device is stopped for a period of time is preferably provided. This makes it possible to avoid the risk of overheating of the heated areas of the material transport device, which could otherwise lead to damage to the material transport device.

A temperature sensor can be provided on the material transport device or close to the material transport device, in order to check the temperature of the material transport device and to make it possible to detect overheating states in a timely fashion.

In one preferred embodiment of the invention, a controller is provided and configured to control the heating device depending on the measured temperature of the material transport device. If the material transport device becomes too cold, the heating output (heating power) is increased. Conversely, the heating output can be reduced if an excessively high temperature of the material transport device or of the material transported on the material transport device is measured and overheating is possibly imminent.

In particular, the construction machine according to the invention can be formed as a road paver, or as a feeder vehicle for supplying such a road paver with hot paving mixture.

### BRIEF DESCRIPTION OF THE DRAWING

In the following, an advantageous embodiment of the invention is described in more detail on the basis of a drawing. The sole FIGURE shows, in a schematic side view, a feeder for a road paver as an embodiment of a construction machine 1 according to the invention.

### DETAILED DESCRIPTION OF THE INVENTION

The feeder vehicle comprises an undercarriage, here a chain undercarriage, that can be operated as a drive of the construction machine 1 by means of a diesel combustion engine. A material hopper 3 on the front end of the construction machine 1, as seen in the working direction, is used to receive and to store material, in this case, paving mixture. The material can be transported out of the material hopper 3 to the back end of the construction machine 1 by using a material transport device 4 formed as a conveyor belt. The conveyor belt 4 ascends thereby.

Diesel for operating the drive of the construction machine 1 is stockpiled in a tank 5 of the construction machine 1. A tank display (not shown) shows the filling level of the tank 4 to the operator on a control stand.

The fuel stored in the tank 5 is fed to a heating device 6 by means of a line 6, whereby this heating device 6 is arranged above the material transport device 4 and whereby this heating device 6 heats this material transport device 4 from above.

The heating device 7 is formed as a direct radiant heater with diesel burner unit in this embodiment. The fuel from the tank 5 is fed to the diesel burner unit 8 of the heating device by means of the line 6. The diesel burner unit 8 generates heat by combusting the diesel fuel from the tank 5. A medium heated by this heat is run through heat conductors 9 of the heating device 7. Radiant heat 10 is emitted by the heat conductors 9 downwards on to the material transport device 4 or on to the material transported on this material transport device 4.

A temperature sensor 11 is provided close to the material transport device 4, for example directly above the material transport device 4. This temperature sensor 11 measures the temperature of the material transport device 4 and/or of the material transported on the material transport device 4. The measured values are communicated to a controller that also controls the operation of the heating device 7. In the event of a risk of overheating, the heating output of the heating device 7 is reduced.

Switching on the heating device and checking the combustion process are handled from a control stand of the construction machine, without it being necessary for the operator to have direct access to and visual contact with the heating device 7 The operation of the heating device 7 can also be coupled to the movement of the material transport device 7. In the event of a standstill of the material transport device 4, whether it occurs because such a standstill is desired or because of a defect, the heating device 7 is switched off in order to avoid overheating of the material transport device 4. For example, a cut-off valve can be provided for this purpose in the line 6.

Monitoring and regulation of the temperature of the material transport device 4 are possible by means of the temperature sensor 11. A warming-up process can moreover be monitored fully automatically, without it being necessary for the operator to have visual contact with the heating device 7.

Based on the depicted embodiment, the construction machine 1 according to the invention can be changed in various ways. For example, a conveying screw can be provided as the material transport device 4 in place of a conveyor belt. The heating device 7 could also be arranged below or within the material transport device 4, for example, between the upper strand and the lower strand of the conveyor belt 4.

1. Construction machine having a fuel operated drive, a material transport device and a heating device configured to heat the material transport device and/or the material transported upon the material transport device, wherein the heating device comprises a radiant heater having a diesel burner, that operates on the same fuel as the construction machine drive.

2. Construction machine according to claim 1 comprising a common tank for the fuel for both the drive and the burner of the heating device.

3. Construction machine according to claim 1 which comprises controls for operating the heating device from a control stand of the construction machine.

4. Construction machine according to claim 1 which comprises a device for switching off the heating device in the event the material transport device comes to a standstill.

5. Construction machine according to claim 1 further comprising a temperature sensor on the material transport device.

6. Construction machine according to claim 6 which comprises a controller configured for controlling the heating device depending on the measured temperature of the material transport device.

7. Construction machine according to claim 1 wherein the construction machine is a road paver or a feeder vehicle for a road paver.
